(19) United States
(12) Patent Application Publication
(10) Pub. No.: US 2013/0014602 A1
(43) Pub. Date: Jan. 17, 2013

(54) METHOD AND APPARATUS TO CONVERT LINEAR AND ROTARY MOTION TO ROTATIONAL TORQUE

(71) Applicant: Victor M. Villalobos, Pensacola, FL (US)

(72) Inventor: Victor M. Villalobos, Pensacola, FL (US)

(21) Appl. No.: 13/346,862

(22) Filed: Jan. 10, 2012

Related U.S. Application Data
(60) Provisional application No. 61/572,107, filed on Jul. 11, 2011.

(51) Int. Cl. F16H 21/18

(52) U.S. Cl. 74/52

(57) ABSTRACT

Two separate motion converter apparatuses and methods using gears acting as levers to convert respectively reciprocal linear and circular motion as input to produce a higher torque rotational output.

The reciprocal linear motion to rotational torque converter apparatus is motivated by a gear radial lever system using reciprocal linear motion actuators acting at a radial distance of zero distance to convert external reciprocal linear motion to greater rotational torque.

The circular motion to rotational torque converter models a sun with satellite rotational sources to motivate a gear radial lever system to produce a greater torque output.

### CROSS-REFERENCE TO RELATED APPLICATION

This application claims the benefit of U.S. Provisional Application No. 61/572,107, filed 11 Jul. 2011, which is hereby incorporated by reference herein.

### TECHNICAL FIELD

This patent application relates to methods and devices used to convert linear and rotary motion to rotational torque. Specifically, there is a need for a device that converts linear and rotary motion to a rotational higher torque from either linear hydraulic, pneumatic or electrical actuator devices or rotary sources such as electrical or hydraulic motors.

### BACKGROUND ART

Linear to rotary motion devices such U.S. Pat. No. 4,282,442 where a device for converting linear reciprocal motion to continuous rotary motion whereby both forward and backward power strokes of the reciprocal motion contribute to the power output of the device, the device including two one-way clutches, the first clutch engaging and the second clutch slipping during the forward stroke and the second clutch engaging and the first clutch slipping during the backward stroke so that the clutches transmit alternatively power to an output shaft, the output shaft being connected to a flywheel which stores energy and which reduces the magnitude of fluctuations in the rotational speed of the shaft.

### SUMMARY OF INVENTION

The main embodiment represents a torque converter composed of at least 6 gears including a grounded internal fixed gear, 4 gears composed as two planet gear pairs solidly attached to their own planetary shaft as one assembly and one torque-output gear. The two planetary gear pair assemblies are positioned radialy on the carrier rotor to allow the free rotation of the planetary gear pairs on their own bearing and positioned to create three connecting radial levers made out of rotating gears which magnify the injected linear motion. The planetary gear shafts are a first-pair shaft and a secondary-pair shaft. The first gear, as a member of the first-pair gear, is positioned on the carrier rotor so as to mesh and to rotate within the internal teeth of the grounded fixed gear while the second gear, as a member of the second gear of the first-pair gear assembly, is positioned to mesh with the third gear of the second-pair gear. The third gear, as a member of the second-pair gear assembly, is mounted on the carrier rotor to mesh with the second gear of the first-pair gear while the fourth gear, as a member of the second-pair gear assembly, is so positioned to mesh with the final output gear. The carrier rotor is connected to a carrier rotor-shaft as one assembly that rotates around the main rotation axis.

### Technical Problem

There is a need for a device that converts linear as well as rotary motion from hydraulic, pneumatic and electrical sources to produce a higher rotational torque such device can be reliable and ease manufacturing.

### Solution to Problem

The solution involves incorporation of a gear configuration apparatus that uses reciprocal linear and rotary external force methods at near the center of the device that motivates an integral radial lever gear system to produce a higher torque output. The lever system is composed of three sets of levers comprising of a single action lever plus two additional radial levers working in series that control the amplification of the torque as a function of the size of the gears. The levers are made out of six gears that act as levers to radially transport and magnify the linear input torque to a greater orbit with higher level of efficiency. The final higher torque output transmission occurs as the fourth gear acceleration is super-imposed onto the carrier rotor's own acceleration and while the carrier rotor serving as the primary accelerating depository rotating platform produces an aggregate final higher torque which is transmitted onto the output gear by the fourth gear.

In the case of the reciprocal linear converter, the translation movement and rotation of the gears is motivated by the linear motion from at least one pair of reciprocal linear actuators injected centrally at a radial distance of zero to obtain maximum leverage (231). The reciprocal linear forces acting on at least one pair of tangential pivot points on the first gear thru tangential pair pivot points are located diametrically opposed at the tangent of the pitch diameter of the spur first gear in line with the center of the gear, to obtain the maximum possible lever action leverage for optimum higher torque purposes. The spur first gear rotates inside a grounded internal gear with twice the number of teeth than the spur first gear that develops a rotational angular speed equal to one but opposite in direction (−1). The carrier rotor assembly function serves as an accelerating depository-rotating platform, which supports the planetary rotation of the two gear pairs.

All assemblies and systems interface and work together to form an internal radial lever system made out of rotating gears to produce the higher torque output thru the conversion of reciprocal linear motion inputted by the linear force input system. The torque-producing system delivers its higher forces to the output-torque system to finally deliver a final rotation solution at a much higher orbit and higher torque efficiency; therefore, establishing and defining its main generic practical use as a torque magnifier.

In the case of the reciprocal linear converter, the central linear force transmission external input system is primarily comprised of a crankshaft device, with at least one pair of tangent pivots points, which is attached to the spur first gear pair and its function is to serve as the linear forces transmission device that allows the conversion of at least one pair of reciprocal vertical and horizontal linear motion from linear actuators acting on a pair of tangent pivot points which introduces a rotation motion around the first gear pair shaft. Such rotation is communicated to the first-pair gear shaft in such manner that the very center of the crankshaft is physically always solidly locked to provide rotation to the spur first gear and second gear, as one solid assembly. The pivot pair points on the crankshaft device act as “tangential circumference rotating pivots” for the spur first gear at a radial distance equivalent to the pitch diameter of the first gear pitch diameter. The crankshaft device can have multiple pairs of pivot points for additional linear pivot pairs working together to promote rotation.

As shown on FIGS. 1 and 2, the linear motion external input force system comprises linear motion actuators which operate at a “null orbit level” equivalent to a radial distance equal to zero for maximum leverage (231), which operates by acting on the gear lever system for an optimum torque output.

As shown on FIG. 2, given a spur gear half size of an internal grounded gear with a designated tangential pivots pair points on its circumference ready to receive reciprocal linear motion and where the spur gear is rotating within the grounded gear as a function of the same reciprocal vertical and horizontal linear motion applied to these points. The action of these reciprocal external linear forces produces a motion composed of an advancing translation motion (271) on the surface of and within the internal gear in the same direction as the linear force while simultaneously producing a negative angular rotation (272) (backwards) on the spur gear proportional to the input linear motion.

The tangential pivot pair points of the half size spur gear when rolling within an internal gear twice its diameter will project two repeatable diametric internal linear trajectories perpendicular to each other; therefore, allowing the use of coordinated reciprocal linear forces to motivate the lever system at a radial distance equal to zero; therefore defining the “null orbit”.

The “null orbit” is defined as the diametric line projected by the linear force straight lirie trajectory pointing through a tangential circumference point of a spur first gear rotating within an internal gear where the spur first gear is half the diameter of the internal gear and in direct line of sight with the center axis of the total rotational system. The “null point” which has a zero radial distance relative to the linear force direction produces a maximum optimum torque input on the Lever System but it is totally invisible and undetected by the rotational output gear assembly and therefore it does not affect the output torque system directly in any way but it allows entrance of the central linear input forces into the lever system for magnification. Thus, defining a method of using reciprocal linear forces to obtain the optimum maximum torque obtainable which includes the steps of: inserting coordinated reciprocal linear forces at a radial distance of zero in a plane defined by tangent pair points of the spur first gear and a main axis of the output gear.

The significance of an “optimum null orbit point” is that it allows for the injection of linear forces external energy into a rotating structure in the line of sight of zero radius(maximum leverage) but which never disturbs or affects the rotational output platform itself directly; therefore, creating an ideal environment for the input of linear energy and torque magnification purposes. Thus defining a method of using reciprocal linear motion to be converted to rotational motion which includes the step of injecting reciprocal linear forces at the optimum null orbit point in the line of sight of the zero radial orbit, said injecting performed without directly affecting the output gear platform itself and thereby creating an unbalanced system and environment for input of reciprocal linear energy and for purposes of torque magnification.

The internal fixed gear is constraint in place by an external grounded platform to allow no rotation but to provide free axial rotating support to the power-output system thru the torque-output gear shaft on the outside and to the carrier rotor assembly thru the carrier rotor-shaft in the inside. The Internal-fixed gear itself should preferably have an even number of teeth.

The torque amplifying system to rotational torque converter is composed of three distinct mechanical assemblies as follows:

(a) A free rotating carrier rotor assembly is composed of a carrier rotor member with an integral built-in extended shaft (carrier rotor-shaft). The carrier rotor member is solidly attached perpendicular to the carrier rotor-shaft which only function is to provide planetary rotation support to the first gear pair and second gear pair assembly attached to the carrier rotor with their shafts rotating parallel to the main axis of rotation. The rotor portion is preferably a flat metal member of a length slightly shorter than the radius of the output-gear with enough thickness and strength to support both gear pairs.

Since the spur first gear is preferably chosen to have half the diameter (or more half the teeth) of the fixed gear, the pitch diameter of spur first gear will reside directly over the universal center axis and this creates an obstruction and therefore an interference with the carrier rotor-shaft rotating about the line of sight of the universal center axis. This is addressed by shaping the carrier-shaft to include a horizontal U-bracket to skirt the spur first gear being extended exactly over the main axis (155) line of sight obstruction.

(b) A first gear pair assembly is made out of the spur first gear and a second spur gear solidly held by its own shaft (first-pair shaft) as one assembly.

The first-pair shaft is free to rotate parallel to the main axis on its own ball bearing device on the carrier rotor member and its center is physically located on the carrier rotor member at a radial distance exactly equal to the pitch radius of the spur first gear in such manner that the spur first gear meshes in contact with the internal teeth of the internal fixed gear and it is able to rotate in a planetary fashion internally around the internal fixed gear held by the carrier rotor assembly. The spur first gear should be chosen to have exactly a number of teeth half of the fixed gear. The first gear pair shaft is physically located shown at a radial distance shown as P1 on FIG. 1.

(c) A second gear pair assembly is made out of a third gear and a fourth gear solidly held by its own shaft (second-pair shaft) as one assembly. The second-pair shaft is free to rotate on its own ball bearing device and its center is physically located on the carrier rotor at a radial distance exactly equal to the pitch diameter of second gear plus the pitch radius of third gear in such manner that the fourth gear teeth are meshed with the internal teeth surface of the internal output-gear. The physical intersection of the pitch diameter of the fourth gear and the output-gear is the mechanical gear boundary delivering the final aggregate higher force to the output-gear for external use. The second gear pair assembly is physically shown at a radial distance shown as P2 on FIG. 1.

The torque-output system is composed of an internal type torque-output gear solidly attached to its own circular back support acting as one whole rotating support structure in the same plane and attached to the torque-output gear which is connected to its own torque-output shaft as one integral assembly.

The torque-output gear is the recipient of the total aggregate amplified torque delivered by the torque-producing system by being in contact with the teeth of the fourth gear. The torque-output gear delivers the final higher torque to the outside world via auxiliary series gears, pulleys, external linear actuators or the like in contact with the torque-output gear.

The total higher torque output of the output-torque system is a function of the output acceleration produced by the rotation of the carrier rotor-shaft rotating around the main axis in conjunction with the acceleration of the fourth-gear, which is mounted on the carrier rotor assembly itself and rotating itself with its own fourth gear-shaft, which creates an aggregate summation of the accelerations.

This patent contemplates also a less efficient method to get the output by using a spur output gear connecting to the fourth gear instead of an internal type.

The Radial lever system which amplifies the torque is made out of three (3) distinct levers working together as follows: a single action first-lever and two series radial levers, the second and third lever.

(a) A single action first-lever (class 2 lever) which operates as a single lever with its resultant force acting on the carrier rotor assembly (at a Point 1) with a force twice the linear input force producing an induced rotation in the same direction than the linear force around its own carrier rotor-shaft axis rotating inside the fixed-shaft axis. The doubling of force is created by the spur first gear center axis acting on the carrier rotor at a radial distance exactly equal to the radius of spur first gear as the gear itself is being pivoted at a rotating fulcrum point defined by the intersection of the pitch diameter of the fixed gear and spur first gear. The injected linear forces acting onto the “tangential pair points” of the spur first gear serve as the applied input linear force. The single action of the first-lever forces the spur first gear (120), which is half size, to rotate within the fixed gear (105) with a negative rotation unity value while the carrier rotor assembly maintains an angular speed nearly equal to the input. The single action first-lever defines the first stage of force magnification.

(b) A series-action two radial lever system which is made out of two (2) levers in series, the second-lever (class 1 lever) in series with the third-lever (class 1 lever) as a lever system where the resultant force output of the second-lever is passed to the third-lever as an input applied force to the third-lever and where the resultant force of the third-lever is acting directly at a distance equivalent to the intersection of pitch diameter of the internal type output-gear and the fourth gear as an applied higher force torque and final output.

(b1) The second-radial lever (class 1 lever) is motivated by the input linear force developed on the spur first gear axis (applied force) at point P1 by the single action first lever while using the intersection plane projected by the pitch diameter of the fixed gear and the spur first gear as a dynamic rotating grounded fulcrum point and exporting radially the higher resultant force at a point occurring exactly at the intersection of the pitch diameter of the second gear and the third gear.

(b2) The third-radial lever (class 1 lever). This lever is made exclusively of the second gear pair and it receives the applied force at the intersection of the pitch diameter of the second gear and the third gear, it uses the center of the second gear pair which is held by the carrier rotor-shaft as the fulcrum point for this lever and it passes its resultant force at a radial distance equivalent to the intersection of the pitch diameter of the fourth gear and the output-gear. The output-gear is the final recipient of the final output higher torque.

The series action of the second-radial lever and the third-radial lever produces the second stage and the third stage of torque magnification respectively. The lever action of the third-radial lever rights the direction of the angular speed of the first gear, which is then transmitted, to the output gear (145) via the fourth gear (140) thru the action of the third-radial lever. Thus, the output gear (145) gains an acceleration of its own as it rotates on the carrier-rotor (110) as a function of the relative size of the second gear (125), the third gear (135) and the fourth gear (140). The internal fixed gear, i.e., the fixed gear (105), should be as large as desired with an even number of teeth, the spur first gear (120), also referred to as the spur first gear, should be nearly half-size diameter of as well as having half the number of teeth of the fixed gear (105). The second gear (125), also referred to as the spur second gear, is either about ten percent larger or smaller than the spur first gear. Preferably, the second gear (125) has a diameter of about 10 percent larger than the spur first gear (120). The third gear (135) is about three or four times larger than the fourth gear (140).

The internal radius of the torque-output gear (145) size is determined by the total summation of the dimensions equal to the pitch radius of the fixed gear (105) plus the absolute value of the difference of the pitch radius of the second gear (125) and the third gear (135) plus the pitch radius of third gear (135) plus the pitch radius of the fourth gear (140).

The linear motion to rotational torque converter (100) has three extended shafts which provide support to the various systems rotating around the main axis of which the center of the fixed-gear shaft (105a) and it plays a major role as it is solidly supported to an external ground platform to provide overall ground support.

The fixed-gear shaft (105a) is a tubular shaft, similar to a pipe with a certain internal bore inside and a certain outside radius circumference dimensions to allow the carrier rotor shaft (110a) on the inside and the torque-output gear shaft (145a) on the outside to turn or rotate freely with their own bearings. The torque-output gear shaft (145a) is connected to the fixed gear (105) as one assembly while being held securely by an external grounded platform.

The torque-output gear shaft (145a) is also a tubular shaft that fits outside the fixed-shaft, which turns or rotates freely therein. A bearing is used to facilitate rotation. The torque-output gear shaft (145a) is connected internally to the torque-output gear (145) solidly as one piece.

The carrier rotor shaft (110a) is a solid shaft that fits inside a fixed-shaft, i.e., the torque-output gear shaft (145a), and may turn or rotate freely therein. A bearing is used to facilitate rotation. The carrier rotor shaft (110a) is connected to the carrier rotor (110) as one solid assembly.

For all practical purposes and because the first gear being half the size of the internal fixed gear, the angular speed of the first gear will be defined as at unity in a reverse direction while the carrier rotor angular speed will remain at unity. Thus, the input motion inputted by the external linear motion remains unchanged and nearly equal to the final output throughout the torque magnification process.

As indicated by epicycle calculation formulae and confirmed by actual built conditions, the angular speed of the spur first gear (120) (when spur first gear equal to half size the internal fixed gear) is calculated to be a negative unity value of the input angular speed (the spur first gear (120), which is half size, and it makes one revolution backwards for every forward revolution of the carrier rotor (110) assembly around the fixed gear (105).

Such negative rotation direction will be later righted by the third-radial lever to have an overall ultimately gear angular output speed which is a function of the size of the second, third and fourth gear.

Thus, defining a method where the carrier rotor (110) assembly maintains the same input angular speed throughout the process where an aggregate acceleration is added by the fourth gear rotation.

The spur first gear (120), which is half size, being part of the first-pair gear (501), simultaneously rotates (272) and translates (271) within the fixed gear (105); therefore, communicating a positive motion of angular speed equal to one to the carrier rotor system and a negative angular speed to the first-pair gear (501), i.e. the carrier rotor assembly (110) passes an angular speed equal to one while the first-pair gear (501) passes a negative angular speed to the second-pair gear (502) assembly and which via the action of the second-pair gear (502) which converts the negative angular speed to a positive value and ultimately onto the output gear (145) as an added acceleration.

As for the output higher torque, the linear force entered at the tangents points, first tangent point (115a) and second tangent point (115b), of the spur-first gear (120) is transferred via the first lever doubling its force output to force the carrier assembly to rotate and translate simultaneously, i.e., the carrier rotor (110), being motivated to rotate around the main axis (155). The same linear force entered at the tangents points (115a) and second tangent point (115b) of the spur first gear (120) is transferred to second lever via the first-pair gear which is further increased by the third lever to the output gear via the second gear pair. Thus, defining a method of using the linear force to rotational torque converter to input reciprocal linear motion into a radial lever system within a rotating system includes the step of using pair of tangent points on the circumference of a spur first gear.

### Advantageous Effects of Invention

Functionally the linear motion to rotational higher torque converter methods, as shown on FIG. 1, allow the conversion of reciprocal linear motion from external energy sources such as hydraulic, pneumatic or electrical actuation to have a higher rotational torque output or for the purposes of human transportation such as human driven bicycles as well as other means of transportation such as cars, boats.

Physically the apparatus of the linear to rotational torque gear configuration is embodied as shown on FIG. 1 thru 6, as the main embodiment of the disclosure, can be built light and as an efficient method to convert reciprocal linear motion to rotational higher torque which can be used by the power and general industry.

As shown on FIG. 7a , 7b, these figures represent the second embodiment of the rotary motion to rotational higher torque converter apparatus.

### BRIEF DESCRIPTION OF DRAWINGS

The drawings illustrate preferred embodiments of the method of the invention and the reference numbers in the drawings are used consistently throughout. New reference numbers in FIG. 1 are given the 100 series numbers, FIG. 2 are given the 200 series numbers and so on. Similarly, new reference numbers in each succeeding drawing are given a corresponding series number beginning with the figure number.

FIG. 1 is a top detail view of a preferred embodiment of the linear to rotational converter torque amplifier.

FIG. 2 is a detail of a spur first gear rotating and translating within a double diameter internal gear showing perpendicular diametrical straight lines trajectories.

FIG. 3 is a perspective view of the apparatus as a preferred embodiment of the torque amplifier with pneumatic actuators.

FIG. 4 is a perspective view of the apparatus as a preferred embodiment of the torque amplifier

FIG. 5 is a perspective of a carrier rotor with the two gear pairs with its own an L-shaped carrier shaft in a preferred embodiment of the torque amplifier.

FIG. 6 is a perspective and the L-shaped carrier in a preferred embodiment of the torque amplifier.

FIG. 7a and FIG. 7b is a top view and cross-sectional view respectively of the second embodiment of a rotary motion to rotational torque converter motivated by two (2) rotational sources using a spur first gear larger than half size diameter of the internal fixed gear diameter.

FIG. 8 is a variation of FIG.7a as a Top View of alternate embodiment of a rotary motion to rotational torque converter motivated by a set of satellite rotational sources using a spur first gear larger than half size diameter of the internal fixed gear diameter and internal type output gear.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention.

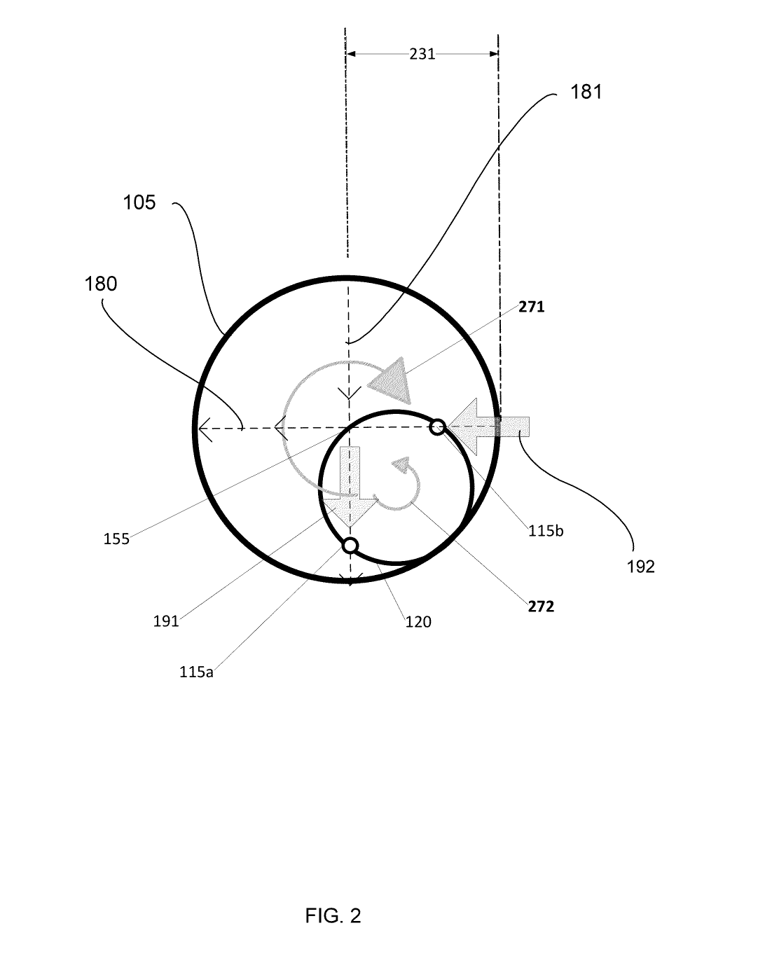

As shown on FIG. 2, an example of the main embodiment illustrates a method of inputting reciprocal linear motion into a radial lever system (100) within a rotating system comprising the steps of: using tangent points (either first pivot point (115a) or the second pivot point (115b) of the circumference of a spur first gear (120), the spur first gear (120) nearly half the pitch diameter, the spur first gear (120) comprising teeth modulus specifications; rotating the spur first gear (120) inside of an internal annulus type gear (the fixed gear (105)) of the same teeth modulus specifications, the internal annulus type gear is twice the pitch diameter of the spur first gear (120); rotating (272) and translating (271) inside the internal annulus type gear (the fixed gear (105) by defining a diametric straight line trajectory (either the horizontal diametric straight line (180) and a vertical diametric straight line (181) directly on plane with the line of sight of the universal center of rotation (105). Given an internal annulus type gear twice the pitch diameter of the spur first gear which when exposed the spur gear is exposed to a linear tangential force, the gear will rotate (272) and translate (271) within the internal annulus gear, maintaining an output rotation speed nearly equal to the input RPM.

By using reciprocal linear motion, such as linear force-1 (191) linear force-2 (192), on the tangent point (either first tangent point (115a) or the second tangent point (115b) on the circumference of a spur first gear (120), the spur first gear (120) nearly half the pitch diameter of the fixed gear (105) will simultaneously rotate and translate within the fixed gear (105) thus defining a repeatable diametric straight line (180 and 181) directly on a plane defined by the line of sight of the universal center of rotation (105) and the diametric straight line at a radial distance equal to zero. Thus defining a method of using the linear motion to rotational torque converter comprises the step of adding reciprocal linear motion onto the spur first gear along a repeatable straight trajectory of a diametric straight line directly on plane with a line of sight of the universal center of rotation. Thus, this method uses a spur first gear (120), which is half size, rotating within an internal gear, the fixed gear (105), as the main protagonist, which uses first tangent point (115a) and second tangent point (115b) on the half gear circumference to travel in a straight diametrical lines (horizontal diametric straight line (180) and vertical diametric straight line (181)) when exposed to a linear force-1 (191) and linear force-2 (192), respectively thus allowing for the use of linear actuators to input forces into the torque converter.

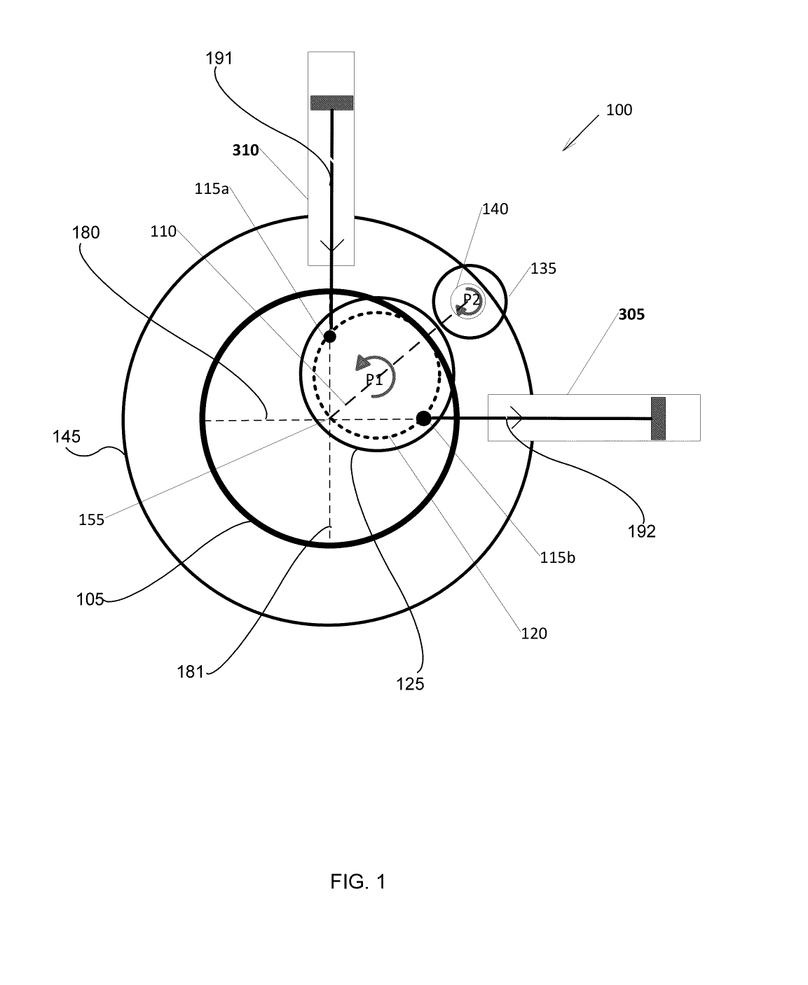

As shown in FIGS. 1 and 2, linear force-1 (191) and linear force-2 (192) act on the tangential pivot points of a spur first gear (120) while being supported by the carrier rotor (110) which produces a rotation (272) and translation (271) motion of the spur first gear (120) within the fixed gear (105).

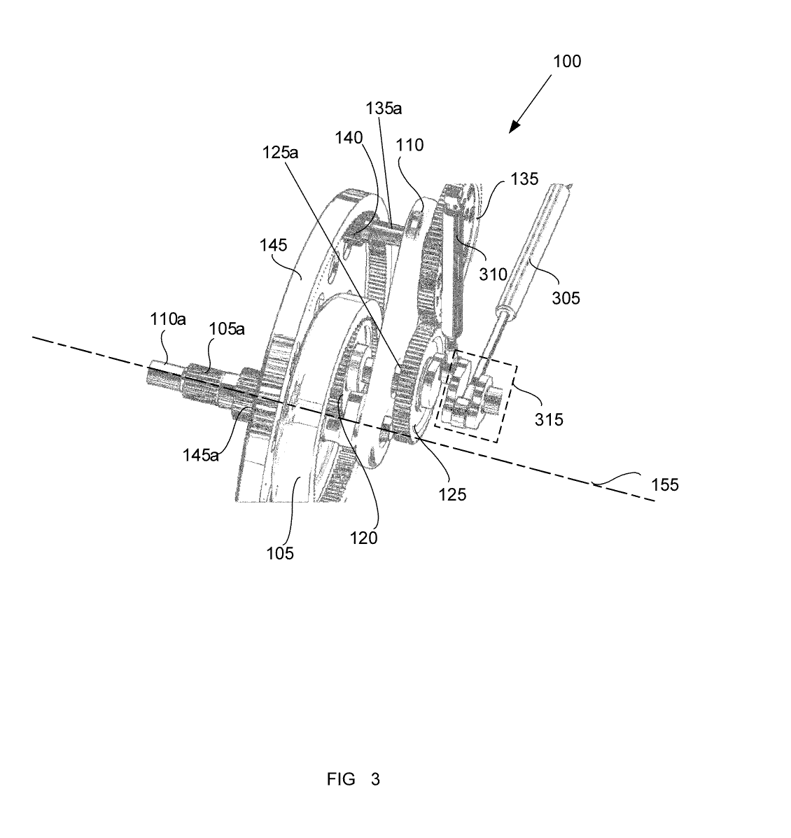

The reciprocal linear forces act simultaneously on both a first tangent pivot point (115a) and a second tangent pivot point (115b), thru the crankcase (315) as shown on FIG. 3, on the circumference of the spur first gear (120), at radial distance nearly half the pitch diameter, which is rotating inside of an internal annulus type gear (the fixed gear (105) and which is by default twice the pitch diameter of the spur first gear will rotate (272) and translate (271) describing a horizontal diametric straight line trajectory (180) and a vertical diametric straight line trajectory (181) directly on the same plane with the line of sight of a universal center of rotation (155).

As shown in FIG. 3, the linear motion to rotational torque converter (100) is powered by one or multiple linear pairs of reciprocal linear force input devices such as electrical, pneumatic or hydraulic linear actuators devices. Preferably, it is powered by a pair of fast acting actuators: a horizontal actuator (305) and vertical actuator (310) acting through a crankshaft (315) shown in the dashed box.

The power input mechanism may include automatic control synchronization working of input strokes thru the crankshaft (315) using an electronic controller (not shown) as well as the location of proximity sensors to sense the location of the strokes. Similarly, output devices may include electrical, pneumatic or hydraulic devices. For example, one or more electrical generators (not shown) may be connected to the torque-output gear (145) to serve as an output device.

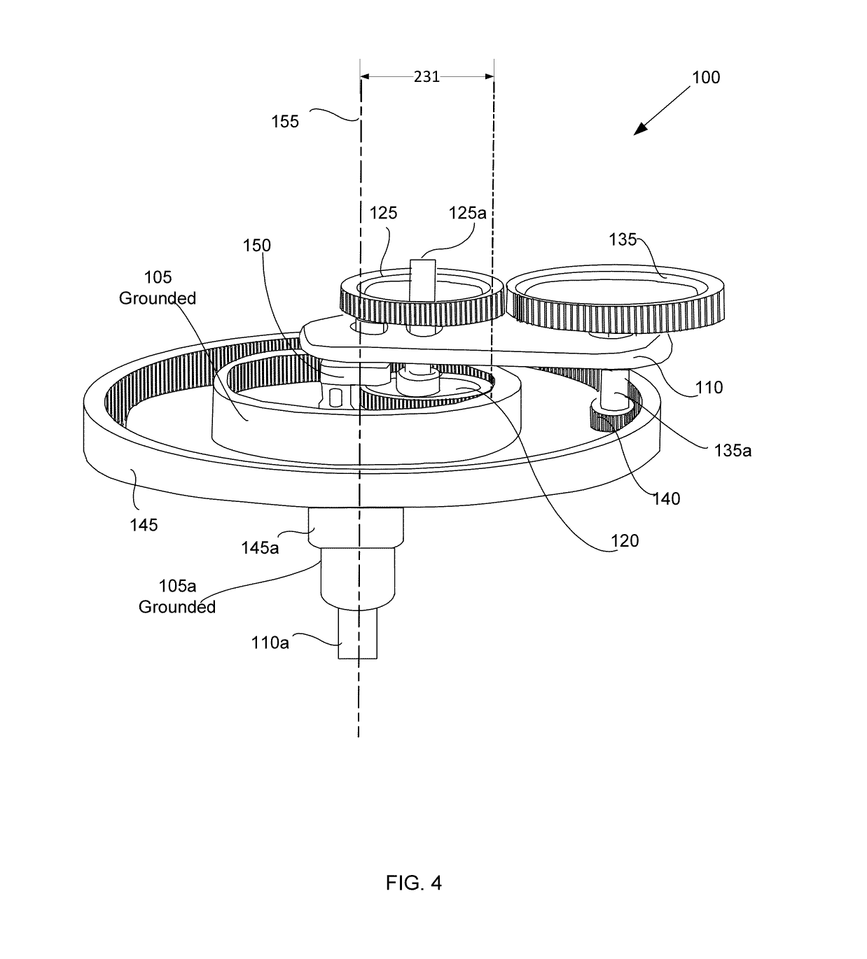

FIGS. 1, 3 and 4 shows a top and perspectives views of a preferred embodiment of a linear force to rotational torque converter (100) according to the invention. The linear force to rotational torque converter (100) includes a vertical actuator (310); a horizontal actuator (305); a fixed gear (105); a carrier rotor (110); a spur first gear (120); a second gear (125); a third gear (135); a fourth gear (140); a torque-output gear (145); a torque-output gear shaft (145a).

The fixed gear (105) is an internal gear, that is, it has teeth (106) facing inward. The fixed gear (105) is grounded so that it does not turn. The first gear (120) rotates within and about the fixed gear (105), which acts like a grounded, reversed sun gear to the first gear (120). The fixed gear (105) preferably has the fixed-gear shaft (105a), which is an integral extended at its center. The fixed gear (105) is preferably held solidly in place by an external grounded platform to allow no rotation but to provide free axial rotating support for the torque-output gear shaft (145a) connected to the torque-output gear (145) on the outside and for the carrier rotor shaft (110a) inside the extended fixed gear shaft (105a). The fixed gear (105) preferably has an even number of teeth.

The carrier rotor (110) is similar to a planet carrier in that it provides the primary rotating support to the first-pair gear made out of spur first gear (120) and second gear (125) rotating as one assembly with the first-pair shaft (125a) and second-pair gear made out of third gear (135) and fourth gear (140) rotating as one assembly with the secondary shaft (135a). The carrier rotor (110) with the carrier rotor shaft (110a) rotates as one assembly motivated by the forces developed by the spur first gear (120).

The first-pair shaft (125a), the secondary shaft (135a) passes through the carrier rotor (110) and all freely rotates within the carrier rotor (110). Bearings may be used where the first-pair shaft (125a), the secondary shaft (135a) pass through the carrier rotor (110). The carrier rotor is preferably a flat metal member of a length slightly shorter than the radius of the output-gear with enough thickness and strength to support both gear pairs.

Thus, the first-pair shaft (125a) and its bearing is located exactly at a radial distance equivalent to pitch diameter of the spur first gear (120). The first-pair shaft (125a) holds the spur first gear (120) and the second gear (125), which turn together as one assembly. The shafts holding gears and used in the preferred embodiments rotate and in turn rotate the gears attached thereto.

Preferably, the first-pair shaft (125a) is free to rotate parallel to the torque-output gear shaft (145a) on its own ball bearing device within the carrier rotor (110). Preferably, the center of the first-pair shaft (125a) is physically located on the carrier rotor (110) at a radial distance from the center of the torque-output gear (145) equal to the pitch radius of the spur first gear (120) in such manner that the spur first gear meshes in contact with the internal teeth of the fixed gear (105) and it is able to rotate in a planetary fashion internally around the fixed gear (105) held by the carrier rotor (110) and the carrier rotor shaft (110a).

The spur first gear (120) is mounted at the bottom end (116) of the first-pair shaft (125a) so as to mesh with the fixed gear (105) and travel around the fixed gear (105) aided by the leverage provided by-the grounded fulcrum created by the fixed gear (105). The spur first gear (120) is preferably half the diameter of the fixed gear (105). The spur first gear (120) preferably has half the teeth of the fixed gear (105).

The second gear (125) is attached to the first-pair shaft (125a) above the carrier rotor (110). The second gear (125) preferably may be larger or small than the spur first gear (120). Preferably, the second gear (125) has a diameter of up to 10 percent larger or smaller than the spur first gear (120). Thus, the spur first gear (120) pitch diameter is defined by half the pitch diameter of the fixed gear (105) and the internal fixed gear (105) is defined approximately to be half of the output gear (145).

The secondary shaft (135a) is also supported by the carrier rotor (110) such that the carrier rotor (110) may freely rotate about the secondary shaft (135a). The secondary shaft (135a) is so named because it is driven by the gears on the first-pair shaft (125a). The secondary shaft (135a) holds the third gear (135) and the fourth gear (140), which turn together as one assembly. Preferably, the secondary shaft (135a) is free to rotate on its own ball bearing device and its center is physically located on the carrier rotor (110) at a radial distance equal to the radius of second gear (125) plus the radius of third gear (135) in such manner that the fourth gear (140) teeth are meshed with the internal teeth surface of the torque-output gear (145). The third gear (135) is positioned on the carrier rotor (110) so as to mesh with the second gear (125).

The fourth gear (140) is positioned on the carrier rotor (110) so that the fourth gear (140) meshes with the torque-output gear (145). The physical intersection of the pitch diameter of the fourth gear (140) and the torque-output gear (145) is the mechanical gear boundary delivering the final aggregate higher force to the torque-output gear (145) for external use.

The torque-output gear (145) is an internal gear, meaning that its teeth face inward. The torque-output gear (145) teeth mesh with the fourth gear (140). The torque-output gear shaft (145a) is located centrally above the fixed-gear shaft (105a). Preferably, the torque-output gear shaft (145a) is attached to the torque-output gear (145) as an integral assembly. The torque-output gear shaft (145a) is then preferably connected exteriorly to auxiliary series of gears, pulleys, external linear actuators or the like.

The carrier rotor shaft (110a) is fixed vertically with respect to the fixed gear to pass through the carrier rotor and provide a fulcrum for carrier rotor rotation. The carrier rotor shaft (110a) is, thus, vertically attached to the carrier rotor (110). Since the pitch diameter of the spur first gear and its teeth preferably resides directly over a central axis, this creates an obstruction to the transit of the pivot shaft (110a) from outside the linear force to rotational torque converter to the carrier rotor (110). This obstruction is transited by shaping the carrier rotor-shaft to include a horizontal U-bracket (150), which is best shown in FIG. 3. Preferably, the carrier rotor shaft (110a) is a solid shaft.

While other embodiments may be possible to provide stability to the gearing of the linear force to rotational torque converter (100), the linear force to rotational torque converter (100) preferably has three shafts forming passage through the center of the torque-output gear (145). These are: the torque-output gear shaft (145a), the fixed-gear shaft (105a), and the carrier rotor shaft (110a).

The torque-output gear shaft (145a) is a tubular shaft, similar to a pipe. The torque-output gear shaft (145a) is connected at a central location to the torque-output gear (145) forming a single assembly. The torque-output gear shaft (145a) defines a passage through the center of the, torque-output gear (145). It is fixed to the torque-output gear (145) and it is primarily used as a rotating member to extract power from the torque-output gear (145).

The fixed-gear shaft (105a) is also a tubular shaft that fits within the power output-shaft and may turn or rotate freely therein. A bearing may be used to facilitate rotation. The fixed-gear shaft (105a) is connected to the fixed gear (105) and it too defines a passage through the torque-output gear (145), but also defines a passage through the center of the fixed gear (105).

The carrier rotor shaft (110a) is positioned within the fixed-gear shaft (105a). The carrier rotor shaft (110a) may be a solid bar or a tubular shaft and it may or may not rotate. Since the spur first gear (120) is preferably half the diameter of the fixed gear (105), this will create an interference with the carrier rotor shaft (110a) running straight through at the centerline of the fixed gear (105). This may be addressed by shaping the carrier rotor-shaft to include a horizontal U-bracket (150) to skirt the spur first gear (120). The horizontal U-bracket (150) may also serve as a means to confine the spur first gear (120) in place.

Thus, the torque-output gear shaft (145a), the fixed-gear shaft (105a) and the carrier rotor shaft (110a) are three extended shafts which provide support to the various components rotating around a main axis (155) of the output gear, which the center of the fixed-gear shaft (105a). The fixed-gear shaft (105a) plays a major role as it is solidly supported to an external ground platform to provide such ground support.

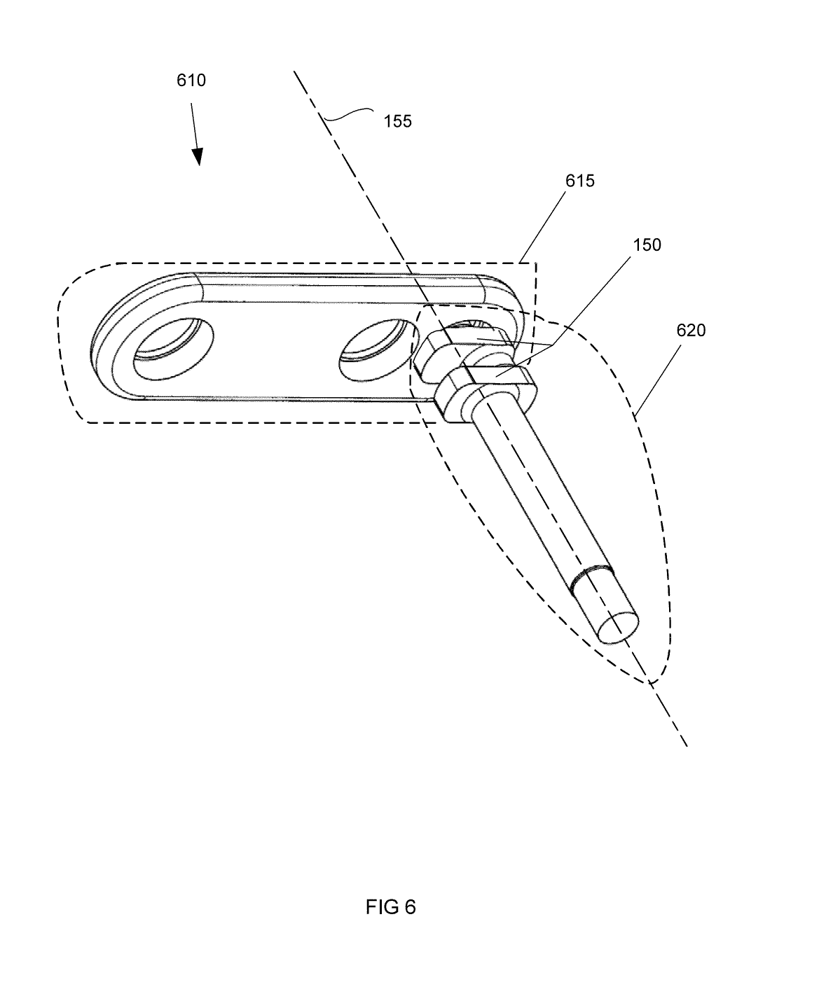

As shown in FIG. 6, the carrier rotor (110) and the carrier rotor shaft (110a) are preferably formed as an L-shaped carrier (610). The L-shaped carrier turns as an integral unit when the gears rotate. The L-shaped carrier (610) comprises a lever component (615) and a shaft component (620), both approximately enclosed within the dashed enclosures in FIG. 6. The shaft component (620) is rotatable so as to provide a fulcrum with respect to the lever component (615).

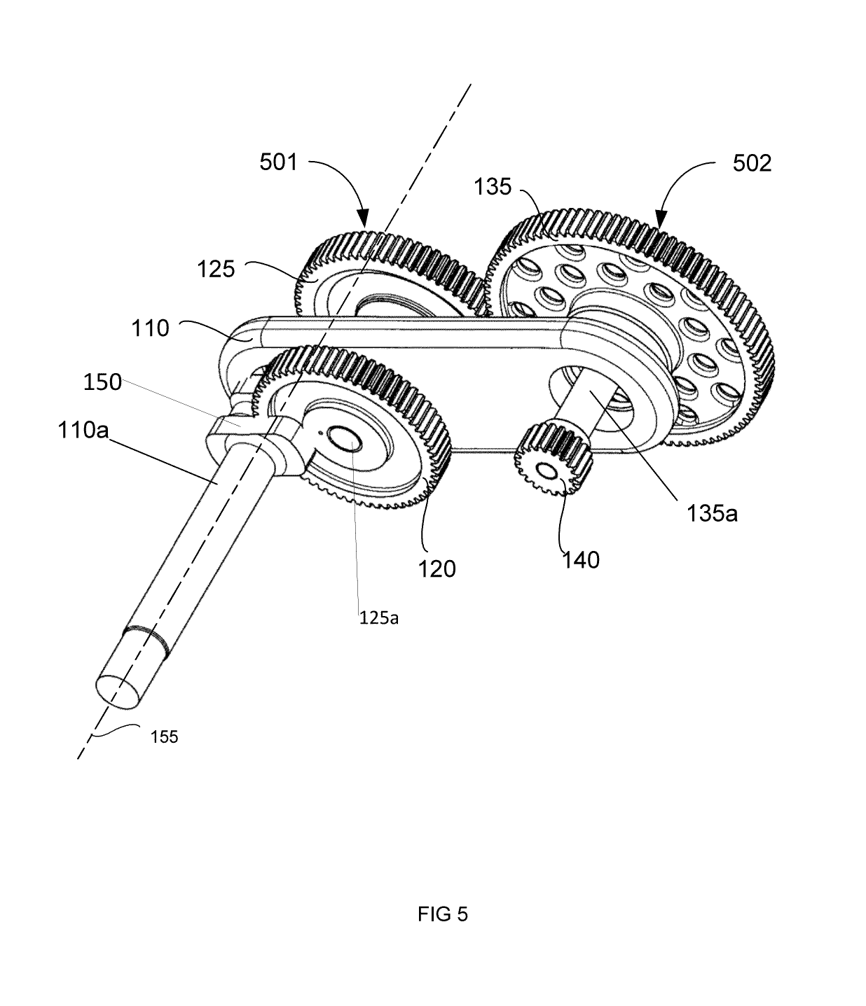

FIG. 5 shows a perspective view of the L-shaped carrier (110) straddled by the first gear pair (501) and the second gear pair (502).

### EXAMPLE 1

The second stage of force magnification occurs as a function of the second-radial lever where the differential in size between the spur first gear and the second gear produces a higher output torque, the third stage of force magnification occurs as a function of the third-radial lever being directly proportional to the ratio of the third gear and the fourth gear. An example of the linear force to rotational torque converter (100) has gear sizes selected as follows:
fixed gear (105)=30 centimeter (cm) diameter; 120 teeth
spur first gear (120)=15 cm diameter; 60 teeth
second gear (125)=17.5 cm diameter; 70 teeth
third gear (135)=22.5 cm diameter; 90 teeth
fourth gear (140)=5 cm diameter; 20 teeth and
torque-output gear (145)=60 cm diameter, 240 teeth.

The reciprocal linear force to rotational torque converter (100) may be powered by using hydraulic, pneumatic or electrical energy linear actuators, preferably, it is powered by a pair of actuators: a horizontal hydraulic actuator (305) and a vertical hydraulic actuator (310) acting on tangential points (115b and 115b respectively as shown in FIG. 1. The power input mechanism may include speed control and automatic control for coordinated and synchronized input strokes using an electronic controller as well as proximity sensors to sense the location of the strokes. Similarly, output linear or rotary devices may include electrical, pneumatic or hydraulic devices. For example an electrical generator (not shown) may be connected to the torque-output gear (145) to serve as an output device. Thus, a method of using the linear force to rotational torque converter comprises using rotary forces produced by a rotational source to turn the spur first gear.

### EXAMPLE 2

Because the force magnification ratio occurs by action of the first, second and third stage of torque magnification, the force magnification is directly proportional to the magnitude of the leverage distance (231), as shown on FIG. 2, and the size of the spur first gear (120), the ratio (G3a) of the third gear (135) to the fourth gear (140) and indirectly proportional to the mathematical absolute value of the difference between the spur first gear (120) and the second gear (125), the gears should be sized according to the following specifications in order to attain a particular force magnification ratio desired.

The correct specifications to be followed and the sizing of the gears should be guided to have the identical gear teeth modulus specifications, made out of a durable steel alloy preferably stainless steel and should be sized according to the following sizing guidelines. Thus, the fixed gear (105) consists of an internal annulus type gear of identical teeth modulus specifications to the spur first gear (120).

The fixed gear (105) is as large as desired with an even number of teeth; the spur first gear (120) is half-size diameter (or nearly half) of, as well as having half the number of teeth of the fixed gear (105) controlling; the second gear (125) is about ten percent larger or smaller than the spur first gear (120). Preferably, the second gear (125) has a diameter of about 10 percent larger than the spur first gear (120). The third gear (135) is about four or five times larger than the fourth gear (140). The internal radius of the torque-output gear (145) size is determined by the total summation of the dimensions equal to the pitch radius of the fixed gear (105) plus the absolute value of the difference of the pitch radius of second gear (125) and the third gear (135) plus the pitch radius of third gear (135) plus the pitch radius of the fourth gear (140).

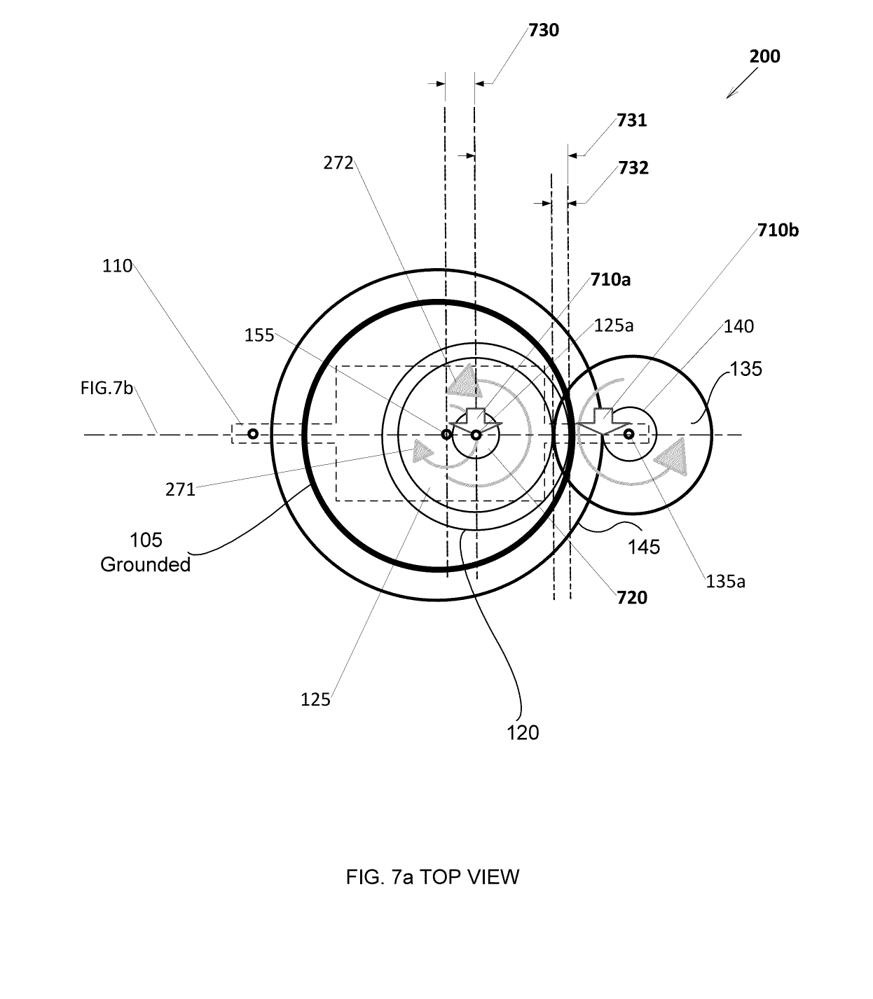

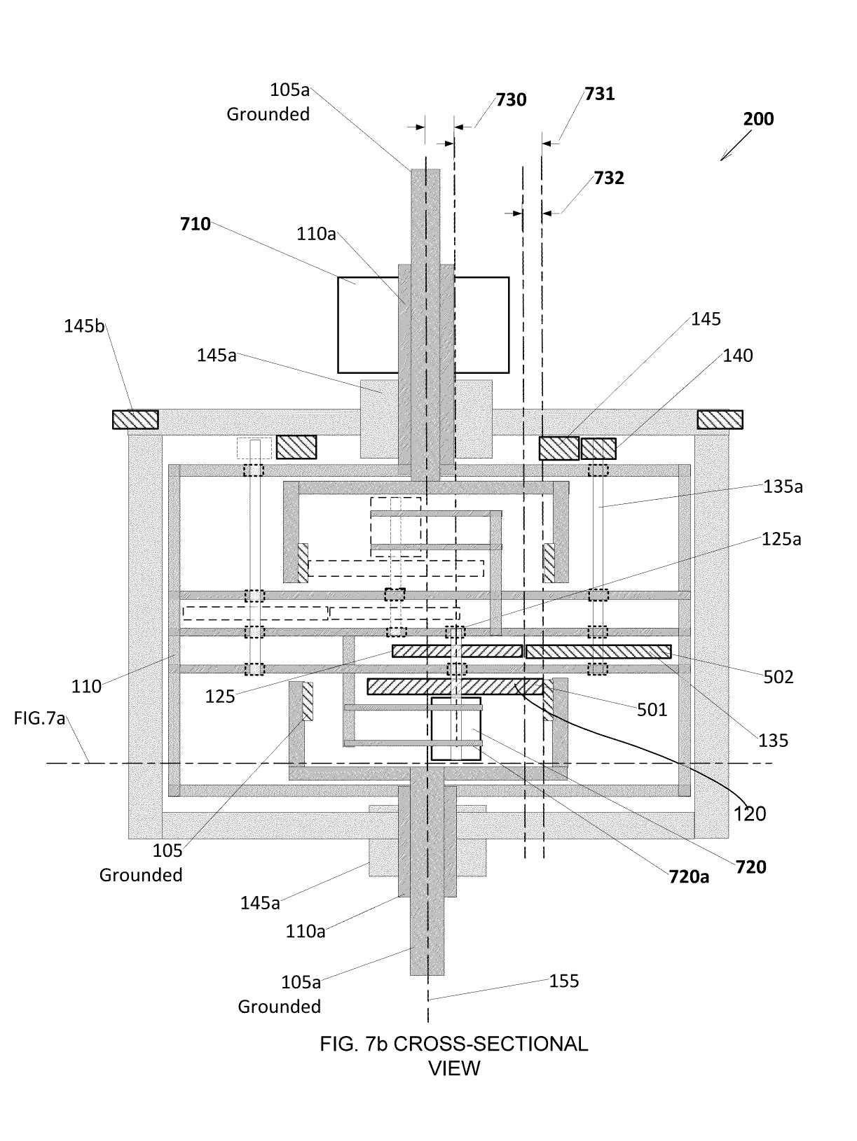

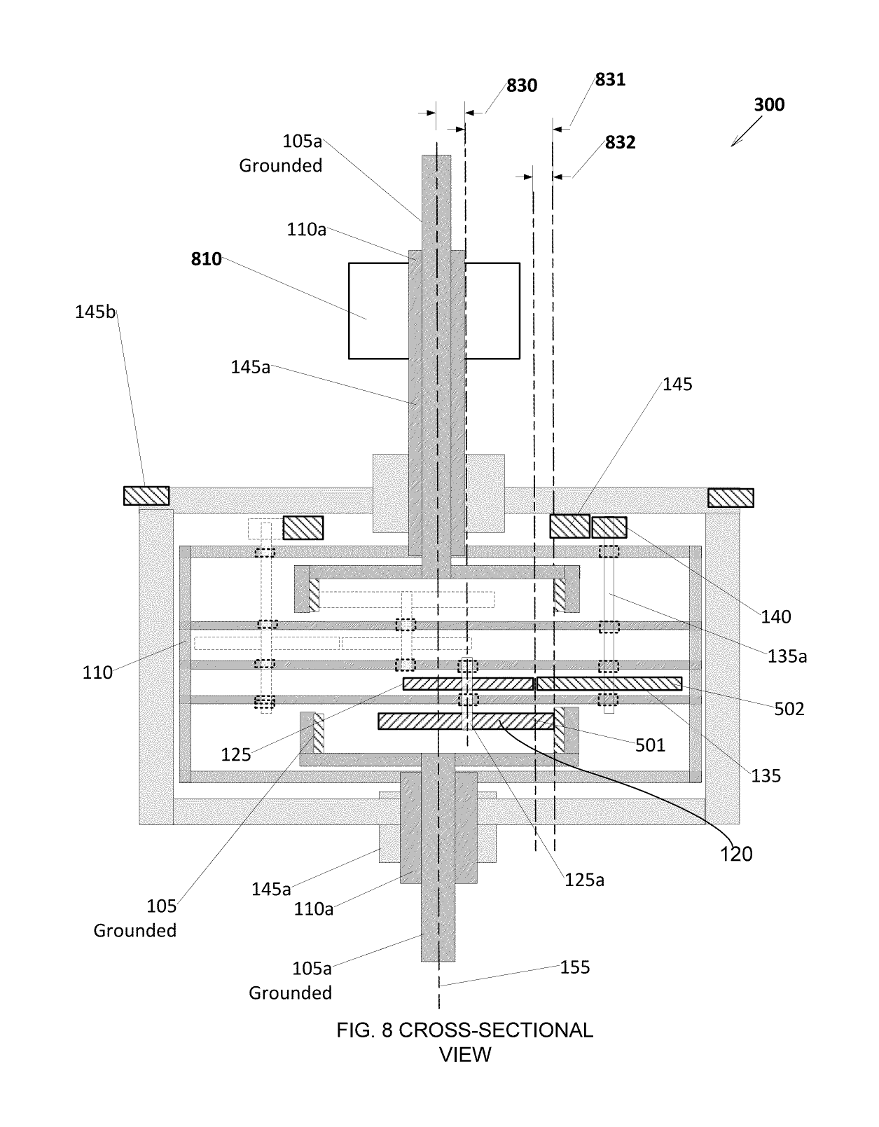

In the second embodiment of the torque converter, as illustrated in FIG. 7a and FIG. 7b, is a rotary motion to rotational torque converter (200) that uses preferably two (2) external rotary sources complemented with one optional central rotational source as a fixed high torque rotation source (710). The rotation sources (720) are supported by the carrier rotor (110). FIG. 8 is an alternate variation (201) of the rotary motion to rotational torque converter system (200).

The main benefit of this application is that allows for the independent control of the RPM separately from the central torque; therefore, defining a method to control the RPM while maintaining the torque constant by using both sources as one unified source to complement each other while rotating independently as rotary sources. This application has special use for land transportation applications where high torque at low RPM is desirable to start moving and where once forward motion has been established then the torque may be reduced while the RPM is increased to maintain speed and it produces the most desirable output that is a blend of high torque with RPM. The satellite rotary sources configuration by itself is far more efficient in producing a higher rotational torque that the central source alone.

This application preferably uses a first gear (120) larger than the radius of the fixed internal gear (105) to obtain a negative angular speed less than unity for the first gear (120) which accelerates the carrier rotor (110). The first-pair (501) and second-pair (502) gears are supported by the carrier rotor assembly (110).

The first-pair (501) gear assembly is comprised of the spur first gear (120) and the second gear (125) which are connected by a common first-pair shaft (125a) located to rotate freely on the carrier rotor (110) at a radial distance equal to the pitch radius of the internal fixed gear (105) less the pitch radius of the spur first gear (120) positioned in such manner as to allow the first gear (120) to mesh with the fixed gear (105) and allow to translate (271) and rotate (272) within the fixed gear (105) and to allow the second gear (125) to mesh with the third gear (135).

The second-pair (502) gear assembly is comprised of the third gear (135) and the fourth (140) gear which are connected by the second-pair shaft (135a) located at a radial distance equal to radius pitch of the internal fixed gear (105) plus the difference of the pitch radius of the second gear (125) less the pitch radius of the first gear (120) plus the pitch radius of the third gear (135) positioned in such manner that the third gear (135) meshes with the second gear (125) teeth and the fourth gear (140) meshes with the spur torque-output (145) gear;

The spur torque-output (145) gear is preferably to be chosen to be of a pitch radius size equal to the pitch radius of the internal fixed (105) gear plus the difference of the pitch radius of the second gear (125) less the pitch radius of the first gear (120) plus the pitch radius of the third gear (135) less the pitch radius of the fourth (140) gear.

The gear configuration accomplishes three desirable objectives: (a) an optimum high input force from rotary source (710) as a function of the lever arm (730) being as short as possible, (b) an optimum angular speed of the first gear (120) as a negative value less than unity which accelerates the carrier rotor (110) and (c) an optimum lever distance (731) being as long as possible which increases the torque output of the system.

The high torque rotary source (710) is supported externally and its output axis is directly rotates carrier rotor shaft (110a) transmitting its input force (710a) directly to the first-pair shaft (125a) thru the carrier rotor shaft (110a), the force output of this source is indirectly proportional to the distance (730). I.e. clockwise rotation of the carrier rotor shaft (110a) by the rotary source (710) provides a clockwise input force (710a) to the first-pair shaft (125a) producing a clockwise translation (271) of the first gear (120) while rotating in a counter-clockwise direction (272). The positive translation (271) of the carrier rotor (110) is transmitted to the second-pair (502) gears via the second gear (125) to third gear (135) connection which is ultimately transmitted to the spur output gear (145) by the fourth gear (140).

The satellite off-center RPM source (720), which rotates in an opposite direction that the high torque source (710), is in direct contact with the first-pair gear shaft (125a) and it is supported laterally by a central support (720a) from the carrier rotor assembly (110) and directly attached to provide rotation to the first-pair shaft (125a). i.e. a negative (counter-clockwise) rotation of the rotary source (720) will produce a clockwise acceleration indirectly proportional to the angular speed of the first gear (120) while producing an aggregate counter-clockwise rotation (272) and a positive translation (271).

The radial distance (731) represents the lever distance at which the input forces are leveraged against the grounded fulcrum fixed gear (105) and therefore motivating the leverage required by the radial lever system to magnify the output torque.

The torque output is directly proportional to the size of the radial distance (731), indirectly proportional to the differential distance (732) and (730), and directly proportional to the ratio of the third gear (135) to the fourth gear (140). The output angular speed of the system (200) is directly proportional to the ratio of the size of the first gear (120) to the size of the radius of the fixed gear (105) less the size of the first gear (120). The size of the first gear (120) is preferably larger than the radius of the internal fixed gear (105) in order to produce a negative angular speed value less than unity of the first gear (120). The amplified high torque and the RPM output blend to produce a greater output thus defining a method to amplify the rotational overall output (710b).

FIG. 8 is a top view of the alternate variation (201) of the rotary motion to rotational torque converter (200) using same satellite rotary sources configuration as the external force input source using internal gear type (in lieu of a spur gear) for an output gear (145) and using a second gear (125) larder than (in lieu of shorter) the first gear (120) to create leverage and increase the radial force output using the leverage system developed by the two gear pair system.

The output of the system (201), represented by (810b) is mirrored in function to the system (200) which uses a first-pair and a second-gear gear configuration such as shown in FIG. 5 as well as a braked spur first gear (120) within the fixed gear ( ) and it is directly proportional to the ratio of the first gear (120) size, represented by (831) and the mathematical difference of the fixed gear (105) and the first gear (120) size, represented by (830), indirectly proportional to the differential distance (832) and directly proportional to the ratio of the third gear (135) to the fourth gear (140). Final Output torque is represented as parameter (810b) in FIG. 8.

### INDUSTRIAL APPLICABILITY

The invention has application to the industrial industry uses, power industry and transportation industry.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### Compliance with the Laws of Thermodynamics and Newton's Law of Motion

Newton's Laws of motion are herein applicable as external radial forces rotate the gear system creating a potential energy system. The obtained higher output torque from the input of external forces thru their own gear actions and acceleration produces a measurable aggregate acceleration totally predictable by Newton's Laws of Motion.

The higher output torque and the gear acceleration are produced by the lever potential energy system that uses the external input forces and where said forces and its acceleration are transported outwards to a larger diameter orbit by the radial lever system itself, therefore, the radial lever and angular acceleration potential system made out of gears constitutes the invention and complies fully with the Laws of Thermodynamics and it is in total accordance with Newton's Laws of Motion.

What is claimed is:

1. The linear motion to rotational torque converter apparatus comprising at least one set of:
A grounded internal fixed gear comprising internal teeth with its own fixed-gear shaft;
a carrier rotor assembly comprised of a carrier rotor with its own carrier rotor shaft ;
a spur first gear of a size equal to half of the fixed gear;
a spur second gear of a size about 5 to 15% larger than the first gear;
a spur third gear about four to five times larger than the fourth gear;
a spur fourth gear;
an internal torque-output gear with its own torque-output shaft as one assembly;
a shaft tubular system comprised of the fixed gear which provides rotational support to the torque-output shaft on the outside and support to the carrier rotor shaft internally.

2. The linear motion to rotational torque converter apparatus of claim 1, comprising at least one set of:
at least one pair of linear type actuators
a crankcase assembly attached to rotate with the first-pair gear assembly;
a first-pair gear assembly with its own shaft comprised of a spur first gear and a second gear connected by a common first-pair shaft located to rotate freely on the carrier rotor at a radial distance equal to the pitch radius of the spur first gear located in such manner as to mesh with the fixed gear and allow to translate and rotate within the fixed gear;
a second-pair gear assembly with its own its own shaft comprised of a third gear and a fourth gear connected by a common the second-pair shaft located at a radial distance equal to the pitch radius of the spur first gear plus the pitch radius of the third gear located in such manner that the third gear meshes with the second gear teeth and the fourth gear meshes with the internal torque-output gear.

3. The linear motion to rotational torque converter apparatus of claim 1, wherein the fixed gear comprises a first pitch diameter and the spur gear comprises a second pitch diameter, the second pitch diameter is exactly half the pitch diameter of the internal fixed gear, the spur gear comprising teeth modulus specifications working with a fixed gear, the fixed gear consisting of an internal annulus type gear of identical teeth modulus specifications, the internal annulus type gear is twice the pitch diameter of the spur gear to enable use of external linear reciprocal source to motivate the spur gear to rotate and translate within the internal annulus type gear, which maintains a first gear a negative angular velocity equal to unity and maintains an output speed nearly equal to the input RPM.

4. The linear motion to rotational torque converter apparatus of claim 1, further comprising:
a torque-output gear shaft of tubular configuration connected at a central location to the torque-output gear so as to define a passage through the torque-output gear;
an extended carrier rotor shaft of tubular configuration within the torque-output gear shaft, the extended first-pair shaft connected to the carrier rotor as one assembly; and wherein the carrier rotor-shaft is positioned within the first gear.

5. A method of using the linear motion to rotational torque converter apparatus of claim 1 that converts reciprocal linear forces to rotational torque thru the use of a radial lever system comprised of levers in series and in parallel within the gear rotating system, the method comprising the step of using pivot pairs of tangent points on the circumference of the spur first gear, the spur first gear being half the diameter of the fixed gear, the spur first gear rotating within the fixed gear, the fixed gear comprising an internal gear twice the diameter of the spur first gear.

6. A method of using the linear motion to rotational torque converter apparatus of claim 1 that converts reciprocal linear forces to obtain an optimum higher torque, the method comprising the steps of: inserting and leveraging such external linear forces at a radial distance of zero in a plane defined by tangent points of the spur first gear, the spur first gear being half the diameter of the fixed gear, the spur first gear rotating within the fixed gear, the fixed gear comprising a grounded internal gear twice the diameter of the spur first gear.

7. The linear motion to rotational torque converter apparatus of claim 1 that converts reciprocal linear forces which uses two planetary gear pair assemblies in series in conjunction with a ground constrained internal gear acting as a round ground fulcrum and a free rotation internal type output gear to obtain a higher torque output produced by the use of levers in series.

8. The method of using the linear motion to rotational torque converter apparatus of claim 1 that converts reciprocal linear forces comprising the step of adding reciprocal linear motion on the spur first gear thru a crankcase along a repeatable straight trajectory of a diametric straight line directly on plane with a line of sight of the main axis formed by the spur first gear being half the diameter of the fixed gear.

9. The method of using the linear motion to rotational torque converter apparatus of claim 1 that converts reciprocal linear forces comprising the step of injecting external motivated linear forces into the torque converter at the optimum radial distance equal to zero in the line of sight of the null orbit giving maximum leverage, said injecting performed without directly altering the rotational output assembly and thereby creating a natural unbalanced condition optimum for the purposes of torque magnification.

10. A rotary motion to rotational torque converter apparatus using satellite off-center RPM and a central torque input rotary sources comprising at least one set of:
a centrally located high torque rotary source which rotates the carrier rotor assembly;
a supplemental satellite off-center RPM set of rotary sources which rotates and translates the first-pair gear directly as one assembly that is supported by the carrier rotor assembly;
a grounded fixed gear comprising internal teeth with its own fixed-gear shaft large enough to contain the first gear;
a carrier rotor assembly comprised of carrier rotor and its own shaft which holds the first-pair and the second-pair gear assemblies;
a spur first gear of a size larger than the radius of the internal fixed gear;
a spur second gear of a size about 5 to 15% smaller than the first gear;
a spur third gear about four to five times larger than the fourth gear;
a spur fourth gear four to five times smaller than the third gear;
a first-pair gear assembly comprised of the spur first gear and the second gear connected by a common first-pair shaft located to rotate freely on the carrier rotor at a radial distance equal to the pitch radius of the internal fixed gear less the pitch radius of the spur first gear located in such manner as to allow the first gear to mesh with the fixed gear and to allow the translation and rotation within the fixed gear and to allow the second gear to mesh with the third gear;
a second-pair gear assembly comprised of the third gear and the fourth gear connected by the second-pair shaft located at a radial distance equal to radius pitch of the internal fixed gear plus the difference of the pitch radius of the second gear less the pitch radius of the first gear plus the pitch radius of the third gear located in such manner that the third gear meshes with the second gear teeth and the fourth gear meshes with the spur torque-output gear;
a spur torque-output gear with its own shaft as one assembly of a pitch radius size equal to the pitch radius of the internal fixed gear less the difference of the pitch radius of the second gear less the pitch radius of the first gear plus the pitch radius of the third gear less the pitch radius of the fourth gear;
a shaft tubular system which supports the converter comprised of the fixed gear shaft which provides rotational support at the ends to the torque-output shaft on the outer exterior and support to the carrier rotor shaft in the inner exterior thru appropriate bearings and
a rotating method to bring external energy internally to power and control the RPM rotary source(s).

11. The method utilized by the rotary motion to rotational torque converter apparatus of claim 10, further comprising at least one but preferably two rotary sources which rotate in the same direction together as a set but in opposite direction to the central high torque source in contact with the first-pair gear assembly that allows for the control of the rotation RPM of the first gear and its translation while maintaining the torque to rotate therefore using both sources as one unified source to blend the RPM and the torque to complement each other while working as separate rotary sources.

12. The rotary motion to rotational torque converter of claim 10 further comprising at least one but preferably two rotary sources rotating in the same direction together as a set but in opposite direction to the central high torque source that uses a first gear larger than the radius of the fixed internal gear to use a rotational higher input torque, which produces a high torque output thru the set of levers made of first-pair and second-pair gears and the RPM sources that accelerates the carrier rotor assembly to increase the rotational torque output of the system.

13. The rotary motion to rotational torque converter apparatus of claim 10 that uses at least one but preferably two rotational sources rotating in the same direction together as a set but in opposite direction to the central high torque source, wherein the fixed gear comprises a first pitch diameter and the spur first gear comprises a second pitch diameter, the second pitch diameter is larger than the pitch radius of the fixed gear, the spur first gear comprising teeth modulus specifications working with a fixed gear, the fixed gear consisting of an internal annulus type gear of identical teeth modulus specifications, the internal annulus type gear is larger than the pitch diameter of the spur gear to enable use of external rotary sources to motivate the spur gear to rotate and translate within the internal annulus type gear, which outputs a high torque while maintaining a first gear negative angular velocity less than unity as a function of the ratio of the size of the first gear being larger than the radius of the internal fixed gear.

14. The method utilized by the rotary motion to rotational torque converter apparatus of claim 10 further comprising at least one but preferably two rotation sources rotating in the same direction together as a set but in opposite direction to the central high torque source, which uses a first gear larger than the radius of the fixed internal gear to produce a negative angular velocity of the first gear less than unity in a braked fashion, which accelerates the carrier rotor shaft as a function of the relative size of the first and fixed gear and input RPM.

15. The method utilized by the rotary motion to rotational torque converter apparatus of claim 10 further comprising at least one but preferably two rotation sources rotating in the same direction together as a set but in opposite direction to the central high torque source which uses a first gear larger than the radius of the fixed internal gear which produces a negative angular velocity of the first gear less than unity in a braked fashion which accelerates the carrier rotor assembly which blends the high torque produced and the RPM to produce a higher output.

16. The method utilized by the rotary motion to rotational torque converter apparatus of claim 10 comprising at least one but preferably two rotary sources rotating in the same direction together as a set but in opposite direction to the central high torque source that converts rotary motion to higher rotational torque thru the use of a radial lever system comprised of levers made out of gears, the method comprising the step of using a central high torque rotary source and a RPM satellite sources that rotates and accelerates the carrier rotor assembly thru the use of levers and a negative less than unity angular velocity of the first gear in a braked fashioned, the spur first gear being larger than the radius of the fixed gear, the spur first gear rotating within the fixed gear, the fixed gear comprising an internal gear diameter larger than the diameter of the spur first gear.

17. The method utilized by the rotary motion to rotational torque converter apparatus of claim 10 comprising the satellite rotary sources that convert rotary motion to higher rotational torque, the method comprising the step of using an off-center satellite rotary set of rotary sources supported laterally by the carrier rotor assembly which rotates and creates acceleration of the carrier rotor assembly itself thru a developed less than unity negative angular velocity of the first gear in a braked fashion, the spur first gear being larger than the radius of the fixed gear, the spur first gear rotating within the fixed gear, the fixed gear comprising an internal gear diameter larger than the diameter of the spur first gear.

18. The method utilized by the rotary motion to rotational torque converter apparatus of claim 10 further comprising use of rotary sources that convert rotary motion to rotational torque, the method comprising the step of using a central high torque rotary source which rotates and creates acceleration of the carrier rotor assembly, the spur first gear being larger than the radius of the fixed gear, the spur first gear rotating within the fixed gear, the fixed gear comprising an internal gear diameter larger than the diameter of the spur first gear.

19. A rotary motion to rotational torque converter apparatus which produces a higher rotational torque output comprising one set of:
a centrally located high torque rotary source which rotates and accelerates the carrier rotate assembly;
a grounded fixed gear comprising internal teeth with its own fixed-gear shaft;
a carrier rotor assembly comprised of carrier rotor and a carrier rotor shaft that holds the first-pair gear and the second-pair gear;
a spur first gear of a size larger than the radius of the fixed gear;
a spur second gear of a size about 5 to 15% smaller than the first gear;
a spur third gear about four to five times larger than the fourth gear;
a spur fourth gear four to five times smaller than the third gear;
a first-pair gear assembly comprised of a spur first gear and a second gear connected by a common first-pair shaft located to rotate freely on the carrier rotor at a radial distance equal to the pitch radius of the internal fixed gear less the pitch radius of the spur first gear located in such manner as to allow the first gear to mesh with the fixed gear and to allow the translation and rotation within the fixed gear and to allow the second gear to mesh with the third gear;
a second-pair gear assembly comprised of a third gear and a fourth gear connected by the second-pair shaft located at a radial distance equal to radius pitch of the internal fixed gear less the difference of the pitch radius of the second gear less the pitch radius of the first gear plus the pitch radius of the third gear located in such manner that the third gear meshes with the second gear teeth and the fourth gear meshes with the spur torque-output gear;
a spur torque-output gear with its own shaft as one assembly of a radius pitch size equal to the pitch radius of the internal fixed gear less the difference of the pitch radius of the second gear less the pitch radius of the first gear plus the pitch radius of the third gear less the pitch radius of the fourth gear and
a shaft tubular system which supports the converter comprised of the fixed gear shaft which provides rotational support at the ends to the torque-output shaft on the outer exterior and support to the carrier rotor shaft in the inner exterior thru appropriate bearings.

20. The method utilized by the rotary motion to rotational torque converter apparatus of claim 19 further comprising the rotary source that converts rotary motion to higher rotational torque thru the use of a radial lever system comprised of levers made out of first-pair gear and second-pair gears, the method comprising the step of using a central high torque source which rotates and creates acceleration of the carrier rotor assembly thru lever action of the first gear and the second gear 5 to 10% size differential using the external force, and the spur first gear being larger than the radius of the fixed gear, the spur first gear rotating in a braked fashion within the fixed gear, the fixed gear comprising an internal gear larger than the diameter of the spur first gear.

21. A rotary motion to rotational torque converter apparatus which produces a higher rotational torque output comprising at least one set of:
satellite off-center RPM set of rotary energy sources which rotate and translate preferably two first-pair gears and a carrier rotor assembly supported by the carrier rotor assembly itself;
a grounded fixed gear comprising internal teeth with its own fixed-gear shaft;
a carrier rotor assembly comprised of carrier rotor and a carrier rotor shaft that holds the first-pair gear and the second-pair gear;
a spur first gear of a size larger than the radius of the fixed gear;
a spur second gear of a size about 5 to 15% larger than the first gear;
a spur third gear about four to five times larger than the fourth gear;
a spur fourth gear four to five times smaller than the third gear;
a first-pair gear assembly comprised of a spur first gear and a second gear connected by a common first-pair shaft located to rotate freely on the carrier rotor at a radial distance equal to the pitch radius of the internal fixed gear less the pitch radius of the spur first gear located in such manner as to allow the first gear to mesh with the internal fixed gear and to allow the translation and rotation within the fixed gear and to allow the second gear to mesh with the third gear;
a second-pair gear assembly comprised of a third gear and a fourth gear connected by the second-pair shaft located at a radial distance equal to radius pitch of the internal fixed gear plus the difference of the pitch radius of the second gear less the pitch radius of the first gear plus the pitch radius of the third gear located in such manner that the third gear meshes with the second gear teeth and the fourth gear meshes with the spur torque-output gear;
an internal torque-output gear with its own shaft with a radius pitch size equal to the pitch radius of the internal fixed gear plus the difference of the pitch radius of the second gear less the pitch radius of the first gear plus the pitch radius of the third gear plus the pitch radius of the fourth gear;
a shaft tubular system which supports the converter comprised of the fixed gear shaft which provides rotational support at the ends to the torque-output shaft on the outer exterior and support to the carrier rotor shaft in the inner exterior thru appropriate bearings and
a rotating method to bring external energy internally to power and control the RPM rotary sources.

22. The method utilized by the rotary motion to rotational torque converter apparatus of claims 10, 19 and 21 further comprising the rotating satellite rotary energy sources that convert rotary motion to higher rotational torque thru the rotation of the first gear rotating within fixed gear and a radial double lever system comprised of levers made out of the first-pair and second-pair gears, the method comprising the step of using the first gear which rotate bound by the fixed gear fulcrum which creates acceleration of the spur first gear and the carrier rotor assembly, the second spur gear diameter being slightly shorter or slightly longer, respective as to the use of a spur or internal gear output gear, than the diameter of the first gear thus creating a lever effect and the spur first gear rotating in a braked fashion within the fixed gear which acts as a rotating fulcrum, the second gear delivering a greater radial force to the third and fourth gears which produces a higher rotational torque.

23. The method utilized by the rotary motion to rotational torque converter apparatus of claims 10, 19 and 21 to produce a higher rotational torque comprising a set of externally powered energy satellite rotary sources that motivate at least one but preferably two sets of first gear(s) to convert the input rotary motion to higher rotational torque thru the lever action of the first-pair and the second-pair gear pair configuration which magnifies and transports the forces radially outward and by the positive acceleration of the carrier rotor produced by the negative rotation of the first gear rotating in a braked fashion within the fixed gear bound by the internal fixed gear which accelerates the carrier rotor assembly and ultimately the output gear set as a function of the first gear angular velocity in a manner and proportional to the ratio value of the size of the first gear to the mathematical differential value of the size of the internal fixed gear less the size of the spur first gear, the spur first gear rotating within the internal fixed gear in a braked fashion, the fixed gear comprising an internal gear larger than the diameter of the spur first gear.
